(19) United States
(12) Patent Application Publication
(10) Pub. No.: US 2002/0188456 A1
(43) Pub. Date: Dec. 12, 2002

(54) Internet based floor covering design review system

(76) Inventors: Tracy L. Francis, LaGrange, GA (US); Mark W. Jones, LaGrange, GA (US); Richard F. Robinson, LaGrange, GA (US)

Correspondence Address: Milliken & Company, P. O. Box 1927, Spartanburg, SC, 29304, US

(21) Appl. No.: 09/875,487

(22) Filed: Jun. 6, 2001

(51) Int. Cl. G06F 17/60

(52) U.S. Cl. 705/1

(57) ABSTRACT

An Internet-based system and method for enabling professionals within the architectural and design communities to review and rank potential floor covering designs before such designs are released for purchase. The system and method permit such professionals to immediately communicate back to the manufacturer of the floor covering material an indication as to the likely commercial potential for such designs prior to such designs being marketed on a broad basis. The participating professionals within the architectural and design communities may also acquire samples of the floor coverings incorporating the various designs for review.

### TECHNICAL FIELD

This invention relates to a system for the interactive evaluation and/or marketing of proposed surface covering, wall covering or floor covering designs, patterns, colors, etc. More specifically, the invention relates to a system whereby a number of pre-qualified users or subscribers such as architectural and design professionals may review designs for such products and provide early feedback to the manufacturer of such products as to the desirability of such designs so as to permit the manufacturer to thereafter concentrate subsequent marketing efforts on those designs of greatest interest to the commercial purchasing community. Focused marketing efforts thereafter are directed to those designs indicated as being most likely to experience broad based acceptance.

Also, users or subscribers may order such products.

### BACKGROUND OF THE INVENTION

Surface coverings such as wall coverings and floor coverings including carpet, carpet tile and the like are features of substantial importance in a building environment. The selection and purchase of floor covering materials for a commercial environment typically represents a fairly substantial investment. Decisions for large scale projects are typically made by professionals within the architectural and design community. Such professionals coordinate floor covering designs with other elements of the building project to yield an aesthetically pleasing environment. Architectural and design professionals thus represent an important link between the manufacturer of the floor covering materials and the final user.

It has long been recognized that certain floor covering designs are more readily accepted and appreciated by the public than are others. It has also long been recognized that such acceptance and long term appreciation may be reinforced by positive marketing efforts directed towards particular designs. Such marketing efforts are typically carried out by the manufacturer of the floor covering material and may be directed to both professionals within the architectural and design communities as well as to the public at large. Thus, each manufacturer provides marketing support to its own designs thereby encouraging the selection of those designs by professionals within the architectural and design communities while simultaneously providing a positive reinforcement of the desirability of such designs within the minds of the ultimate user.

Heretofore, the manufacturer would typically develop a number of different designs for floor covering materials and would independently identify those designs believed to have the highest likelihood of realizing commercial success. Those designs identified as having the greatest commercial potential would thereafter be the focus of substantial marketing efforts while those designs considered to have less potential would typically receive a correspondingly reduced level of marketing attention. In this manner, it was believed that those designs most likely to be used would be promoted to the fullest extent possible. While this mechanism for the allocation of marketing resources has been generally successful, it has been largely dependent upon the independent judgment of individuals within the manufacturing organization and has generally not made substantial use of input from the architectural and design communities at large. Thus, in some instances designs which were believed to be highly attractive to a broad cross section of the population were ultimately determined to have a relatively narrow appeal which could not be overcome by positive marketing efforts. Likewise, in some instances it has been determined that designs which were initially perceived as having relatively limited use were found to be widely desirable. In such instances, marketing resources were often times already committed to other designs having less commercial potential.

### SUMMARY OF THE INVENTION

The present invention provides advantages and alternatives over the prior art by providing a computer or Internet-based system and method for enabling professionals within the architectural and design communities to review potential surface covering, wall covering or floor covering designs, patterns or colors before such designs are released for purchase. The system and method permit such professionals (users or subscribers) to immediately communicate back to the manufacturer of the floor covering material an indication as to the likely commercial potential for such designs prior to such designs being marketed on a broad basis. The participating professionals within the architectural and design communities may also acquire samples and/or order products incorporating the various designs for review. The information retrieved from the professionals within the architectural and design community may thereafter be utilized by the manufacturer to promote those designs which are identified by the architectural and design professionals as being most desirable.

According to one exemplary embodiment, pre-qualified subscribing professionals within the architectural and design communities are alerted on a periodic basis by an electronic mail (E-mail) message as to the availability of new designs for review and consideration. The E-mail alert includes an embedded link to a site maintained by the manufacturer of the floor covering material. Through that site, the subscribing professionals within the architectural and design communities may access images of the potential new designs and immediately comment on the commercial potential of each individual design. The results of the review by the subscribing professionals may be tabulated and stored for retrieval by the manufacturer of the floor covering material. The manufacturer may thereafter select certain of those designs to be the subject of comprehensive future marketing efforts while other designs may be identified as warranting more modest marketing efforts or potentially complete abandonment. The images provided to the subscribing professionals may include electronic links to an ordering site maintained by the manufacturer of the floor covering material to permit the acquisition of a physical sample and/or product if desired. The present invention thus provides an Internet-based method and Web site system to provide the highly efficient evaluation of a large number of potential floor covering designs by a significant number of qualified professionals thereby providing a large number of meaningful sample points concerning the likely commercial acceptance of a given design. The data obtained from this sample population of knowledgeable individuals may be used to identify designs worthy of significant subsequent marketing effort.

The subscribers or users get the benefit of being the first ones to see the new designs and to order samples and/or products incorporating the new designs. Also, if sufficient subscribers order products based on their review of the new designs, then this may further reduce the need for additional marketing efforts.

### BRIEF DESCRIPTION OF THE DRAWINGS

These and other features and advantages of the invention will now be described with reference to the drawings of certain potentially preferred embodiments, practices and procedures which constitute a part of this specification and which are intended to illustrate and not to limit the invention, and in which:

FIG. 1 is a high-level architectural drawing illustrating the primary components of a Web-based system according to an exemplary embodiment of the present invention.

FIGS. 2-5 are exemplary screen displays illustrating the design presentation and ranking function of one example of the present invention; and

FIG. 6 is an exemplary arrangement of designs for use in printing and sample ordering in accordance with one example of the present invention.

While the invention has been illustrated and broadly described above and will hereinafter be described in connection with certain potentially preferred embodiments and practices, it is to be understood that in no event is the invention limited to such illustrated and described embodiments and practices. On the contrary, it is intended that the present invention shall extend to all alternatives and modifications as my embrace the general principles of this invention within the true spirit and scope thereof.

### DETAILED DESCRIPTION OF THE INVENTION

To facilitate a complete understanding of the invention, the following terms and acronyms are used throughout the detailed description:

Client-Server.

A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Hyperlink.

A navigational link from one document to another, or from one portion (or component) of a document to another. Typically, a hyperlink is displayed as a highlighted word or phrase that can be selected by clicking on it using a mouse to jump to the associated document or documented portion.

Internet.

A collection of interconnected (public and/or private) networks that are linked together by a set of standard protocols (such as TCP/IP, HTTP and HTTPS) to form a global, distributed network. (While this term is intended to refer to what is now commonly known as the Internet, it is also intended to encompass variations which may be made in the future, including changes and additions to existing standard protocols.)

World Wide Web (“Web”).

Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP or HTTPS, and the Web pages are encoded using HTML. However, the terms “Web” and “World Wide Web” are intended to encompass present and future markup languages and transport protocols which may be used in place of (or in addition to) HTML and HTTP.

Web Site.

A computer system that serves informational content over a network using the standard protocols of the World Wide Web. Typically, a Web site corresponds to a particular Internet domain name, such as “MILLIKEN.COM,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language).

A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

HTTP (HyperText Transport Protocol).

The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET<URL>, causes the server to return the document or file located at the specified URL. HTTPS (HyperText Transport Protocol Secured) is used for access to a secured server. HTTPS uses SSL (Secured Sockets Layer) to encrypt the data and may provide user authentication.

URL (Uniform Resource Locator).

A unique address which fully specifies the location of a file or other resource on the Internet. The general format of a URL is protocol://machine address:port/path/filename. The port specification is optional, and if none is entered by the user, the browser defaults to the standard port of whatever service is specified as the protocol.

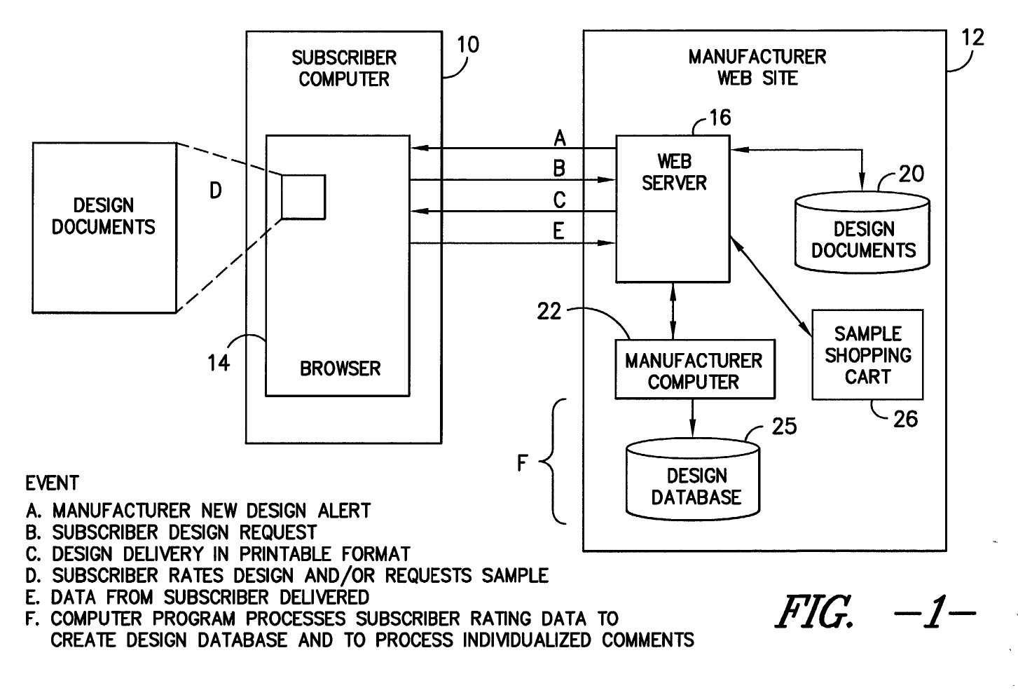

Turning now to the figures, FIG. 1 illustrates the general architecture of an exemplary design review system that operates in accordance with the present invention. The system includes a subscriber computer 10 linked via the Internet to a manufacturer Web site 12 the subscriber computer 10 may be any type of appropriate computing device that allows a pre-qualified user (i.e. “subscriber”) to interactively browse Web sites on the World Wide Web via a Web browser 14. By way of example only, the subscriber computer 10 may be a personal computer (PC) that runs a Windows based operating system. The Web browser 14 may be any suitable browser including, by way of example only, Microsoft Internet Explorer or Netscape Navigator.

The manufacturer Web site 12 is a multifunctional site that provides various functionality to allow pre-qualified subscribers such as professionals within the architectural and design communities to view new surface covering, wall covering or floor covering designs, patterns, colors, etc. in printable format, to comment on the 5 desirability of such new designs and to order or products incorporating such designs while on-line. Typically, this site will be operated by the manufacturer of the surface covering, wall covering or floor covering products or materials or other business that handles the development and marketing of new product designs.

As illustrated, the manufacturer Web site 12 incorporates a Web server 16 with access to a catalog of design documents 20 in HTML format which have been identified by the manufacturer for presentation to qualified subscribers. The design documents 20 may be requested, retrieved, and reviewed by subscribers via the Web browser 14. Information exchange between the subscriber computer 10 and the manufacturer web site is preferably carried out as a series of HTTP messages. As will be discussed further hereinafter, the design documents 20 are preferably in HTML format and include a printable display of new floor covering design as well as fields to enter standardized and/or individualized comments regarding the subscriber's perception of the commercial viability of the particular design and embedded links to other documents or addresses of interest. By way of example. The design documents 20 also may include links to ordering sites at which a subscriber may request the preparation and delivery of a physical sample and/or products incorporating an identified design. As will be appreciated, the manufacturer Web site 12 is preferably multi-functional and is controlled by a computer 22 running various software so as to provide a number of services such as contact information, product care data, account information and the like which are not illustrated and described in reference to the present invention. Thus, it is to be understood that the manufacturer Web site 12 is in no way limited to such elements as are particularly illustrated and described in relation to the present invention.

As illustrated in FIG. 1 upon the development of one or more new product designs such as floor covering designs an alert message is sent to the pre-qualified subscriber. The alert message is preferably in the form of an E-mail message including a link back to the appropriate URL address within the manufacturer Web site 12. According to one potentially preferred practice, new designs are made available for review according to a substantially regular schedule of approximately every fourteen days. However, it is likewise contemplated that design alerts may be sent substantially randomly as new designs are created.

Once a new design alert is received by the subscriber, the subscriber may thereafter utilize the internal links within the new design alert to request delivery of the design documents 20 incorporating printable images of the various new designs. Such design documents are preferably communicated back to the requesting subscriber in a PDF format which may be viewed by the subscriber utilizing image display software such as Adobe Acrobat Reader or the like. The subscriber may utilize the design documents to print record copies of the designs for future reference. Preferably such printing may be carried out by use of embedded print commands within portions of the design documents themselves.

Aside from the ability of the subscriber to view new designs and to print record copies of such designs for future use, the present invention also contemplates that the subscriber may provide interactive and substantially immediate feedback to the manufacturer regarding each of the designs and its likelihood of market acceptance. According to one potentially preferred practice, such feedback from the subscriber is obtained by providing a menu of discrete selectable responses indicating varying levels of likelihood of use of a corresponding illustrated design. The subscriber is permitted to select one response from the menu which is then communicated back to the manufacturer web site 12. The rating provided by the subscriber is preferably scaleable according to a standardized criteria which provides a scaled score associated with each selected response.

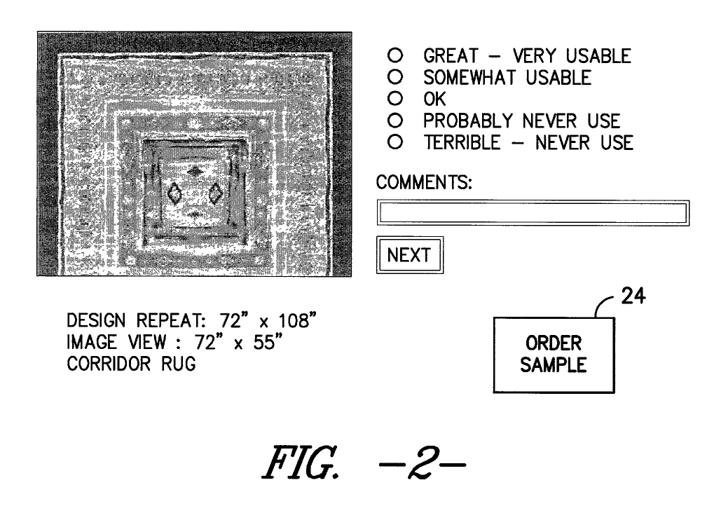

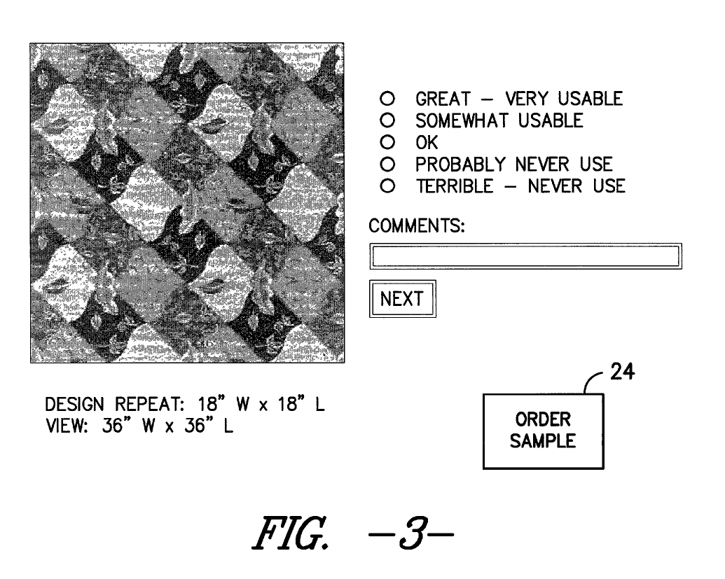

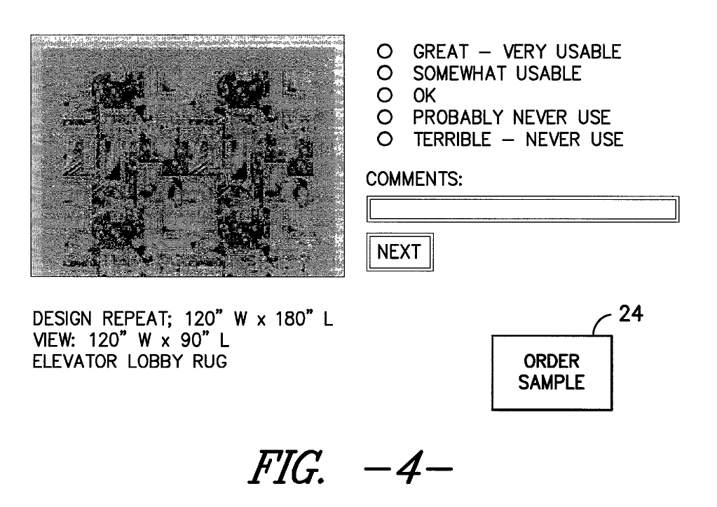

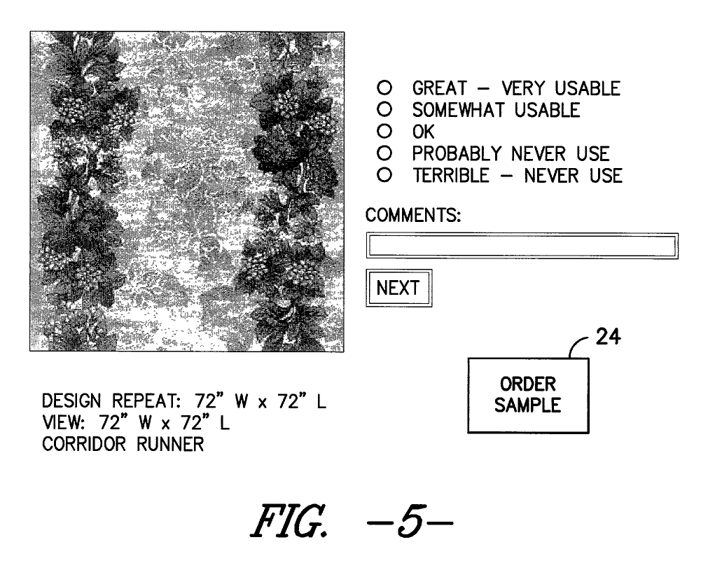

In the potentially preferred practice, the ranking for each pattern is communicated back to the manufacturer Web site 12 and is assigned a scaled numerical value corresponding to the input by the subscriber. Accordingly, in reference to the ranking scale illustrated in FIGS. 2-5, in the event that a subscriber ranks a new design as being very usable that design is accorded a numerical ranking of five, while if the design receives a ranking from the subscriber indicating that the design would never be used that design receives a ranking of one. As responses are received from various subscribers regarding each of the discrete designs, the manufacturer computer 22 is utilized to tabulate the responses and to store those responses in a predetermined format within a design database 24 accessible to the manufacturer. By evaluating a relatively large number of such responses from a known reputable pool of qualified professionals within the architectural and design communities it is believed that a meaningful and accurate indication of the commercial value of a particular design may be obtained. Those designs which are identified as having the greatest likelihood of commercial success may thereafter be the subject of enhanced marketing efforts to the broader community of users while those that receive poor ratings may receive less marketing effort or may be abandoned entirely.

As illustrated, ranking inquiries are preferably associated with each individual design in a dedicated screen display. Such correspondence between a single design and inquiry set on a dedicated display may be useful in avoiding confusion. Preferably, only a single standardized response is permitted for each design although it is contemplated that the subscriber may enter individual comments regarding a particular design should they so desire.

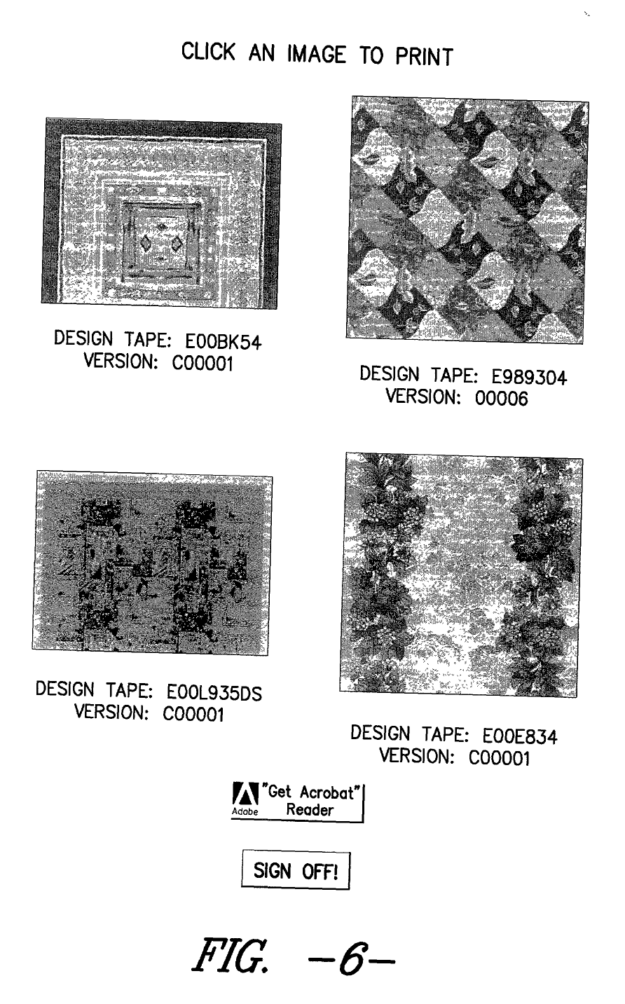

According to another aspect of the present invention, it is contemplated that the subscriber may be provided with the opportunity to order a physical sample and/or product incorporating a design which may be of interest to that subscriber. According to a first embodiment of the invention, it is contemplated that such samples may be ordered via direct contact between the subscriber and the manufacturer. Accordingly, it is contemplated that the design documents communicated to the subscriber will preferably include a screen display depicting an arrangement of the various designs in association with particular design designations which may be used when contacting the manufacturer. One such arrangement of images for use in printing and personal sample and/or product ordering is illustrated in FIG. 6. Thus, by contacting the manufacturer and identifying the design tape number and version of the sample of interest, a physical sample and/or product may be obtained.

According to another embodiment of the invention as illustrated in FIGS. 1-5, it is also contemplated that the subscriber may order a physical sample on-line. By way of example only, it is contemplated that such ordering may be carried out by means of a linking button 24 on the display screen corresponding to each discrete design under evaluation. In operation, the activation of such a linking button will direct the subscriber to a sample and/or product shopping cart program 26 at which an order may be placed for a physical sample and/or product of the particular design of interest. The utilization of such on-line ordering of a physical sample and/or product has the potential benefit of avoiding the necessity of personal interaction between the subscriber and the manufacturer to obtain a sample or to order product. However, it is to be understood and appreciated that the basic features of the invention as previously described in relation to the acquisition and evaluation of new samples is in no way dependent upon the presence or absence of such on-line sample and/or product ordering capabilities.

As will be appreciated, while the invention has been illustrated and described herein with reference to certain embodiments, practices and procedures, these embodiments, practices and procedures have been presented by way of example only and in no instance are to be construed as in any way limiting the scope of the invention. Rather, it is contemplated that modifications and variations embodying the principles of this invention may likely occur to those of skill in the art. It is thus contemplated and intended that present invention shall extend to all such modifications and variations as may incorporate the broad aspects of the invention within the true spirit and scope of the appended claim and all equivalence thereto.

1. An interactive computer based system for review of product designs, patterns and/or colors, such as wall covering, surface covering or floor covering designs, comprising a computer controlled internet-based interactive communications site for electronically communicating to a multiplicity of pre-qualified subscribers one or more product designs in combination with a standardized rating scale for indicating the likelihood of use of said designs and thereafter electronically retrieving from at least a portion of said subscribers scaled rating responses for at least a portion of said designs whereby the likelihood of use of said at least a portion of said designs may be estimated.

2. The system as recited in claim 1, wherein said subscribers are selected from the group consisting of professionals within the architectural and design communities.

3. The system as recited in claim 1, including an alert system for alerting said subscribers when new product designs are available for review.

4. The system as recited in claim 3, wherein said alert system comprises an e-mail delivery system.

5. The system as recited in claim 1, wherein said one or more product designs are electronically communicated as printable web documents to computers operated by said subscribers.

6. The system as recited in claim 5, wherein said printable web documents include embedded print commands activatable by said subscribers.

7. An interactive computer based system for review of floor covering designs, comprising a computer controlled internet-based interactive communications site for electronically communicating to a multiplicity of pre-qualified subscribers one or more floor covering designs in conjunction with a ballot style rating scale including a plurality of selectable response menu items indicating varying levels of likelihood of use of said one or more floor covering designs wherein only a single menu item may be selected for each design such that a single rating selection may be made by each of said subscribers and transmitted back to the Web site for each of said one or more floor covering designs whereby the likelihood of use of said one or more floor covering designs may be estimated.

8. The system as recited in claim 7, wherein said system includes a computer based program for tabulating and storing responses from said subscribers.

9. The system as recited in claim 7, wherein said subscribers are selected from the group consisting of professionals within the architectural and design communities.

10. The system as recited in claim 7, including an alert system for alerting said subscribers when designs are available for review.

11. The system as recited in claim 10, wherein said alert system comprises an e-mail delivery system.

12. The system as recited in claim 7, wherein said one or more floor covering designs are electronically communicated as printable web documents to computers operated by said subscribers.

13. The system as recited in claim 12, wherein said printable web documents include embedded print commands activatable by said subscribers.

14. The system as recited in claim 7, further comprising means for said subscribers to enter individualized comments concerning said one or more floor covering designs.

15. An interactive computer based system for review of product designs, patterns and/or colors comprising a computer controlled internet-based interactive communications site for electronically communicating to a multiplicity of pre-qualified subscribers one or more product designs in conjunction with a ballot style rating scale including a plurality of selectable response menu items indicating varying levels of likelihood of use of said one or more product designs wherein only a single menu item may be selected for each design such that a single rating selection may be made by each of said subscribers and transmitted back to the Web site for each of said one or more product designs whereby the likelihood of use of said one or more product designs may be estimated, the system further comprising means for said subscribers to enter individualized comments concerning said one or more product designs and an interactive electronic shopping cart accessible by said subscribers for ordering physical samples and/or products incorporating said one or more product designs.

16. The system as recited in claim 15, wherein said system includes a computer based program for tabulating and storing responses from said subscribers.

17. The system as recited in claim 15, wherein said subscribers are selected from the group consisting of professionals within the architectural and design communities.

18. The system as recited in claim 15, including an alert system for alerting said subscribers when new product designs are available for review.

19. The system as recited in claim 18, wherein said alert system comprises an e-mail delivery system.

20. The system as recited in claim 15, wherein said one or more product designs are electronically communicated as printable web documents to computers operated by said subscribers.

21. The system as recited in claim 20, wherein said printable web documents include embedded print commands activatable by said subscribers.

22. A method of evaluating the potential market acceptance of one or more floor covering designs with the assistance of pre-qualified associates, the method comprising:
electronically communicating to a multiplicity of pre-qualified associates one or more floor covering designs in combination with a standardized rating scale comprising a plurality of selectable responses indicating varying levels of likelihood of use of said one or more floor covering designs;
electronically receiving from at least a portion of said associates their selected responses indicating the likelihood of use of said one or more floor covering designs; and
tabulating and archiving the selected responses received from said associates.

23. The method as recited in claim 22, wherein said associates are selected from the group consisting of professionals within the architectural and design communities.

24. The method as recited in claim 22, wherein the electronically communicating and electronically receiving steps are carried out over the internet.

25. The method as recited in claim 24, wherein said one or more floor covering designs are electronically communicated to computers operated by said associates in the form of printable web documents.

26. The system as recited in claim 25, wherein said printable web documents include embedded print commands activatable by said subscribers.

27. A method of evaluating the potential market acceptance of one or more floor covering designs with the assistance of pre-qualified associates, the method comprising:
providing an interactive web site for the communication and receipt of data via the internet;
electronically communicating to a multiplicity of pre-qualified associates web documents illustrating one or more floor covering designs in combination with a standardized rating scale comprising a plurality of selectable responses indicating varying levels of likelihood of use of said one or more floor covering designs;
electronically receiving from at least a portion of said associates responses indicating the likelihood of use of said one or more floor covering designs; and
tabulating and archiving the selected responses received from said associates, wherein the electronically communicating and electronically receiving steps are conducted through said interactive web site.
